(19) United States
(12) Patent Application Publication
(10) Pub. No.: US 2012/0082047 A1
(43) Pub. Date: Apr. 5, 2012

(54) USER EQUIPMENT MEASUREMENT FOR INTERFERENCE MANAGEMENT IN HETEROGENEOUS NETWORKS WITH FEMTO CELLS

(75) Inventor: Huaming Wu, San Diego, CA (US)

(73) Assignee: ZTE (USA) INC., Iselin, NJ (US)

(21) Appl. No.: 13/251,135

(22) Filed: Sep. 30, 2011

Related U.S. Application Data
(60) Provisional application No. 61/389,135, filed on Oct. 1, 2010.

(51) Int. Cl. H04W 24/02; H04W 72/08

(52) U.S. Cl. 370/252

(57) ABSTRACT

Systems and methods for interference management are disclosed. Exemplary embodiments disclose systems and methods configured to identify victim or interfering mobile stations and transmit measurement instructions to the victim or interfering mobile stations. According to certain embodiments, the mobile stations monitor downlink link quality and report this information back to the serving cells. The serving cells are configured to schedule the mobile stations in the subframes whose downlink link quality is high, determined based on a predetermined threshold.

### CROSS-REFERENCE TO RELATED APPLICATIONS

This application claims priority to U.S. Provisional Patent Application No. 61/389,135, filed on Oct. 1, 2010, entitled “UE Measurement for Interference Management in HetNet with Femto Cells,” the entirety of which is incorporated by reference herein.

### FIELD OF THE INVENTION

The invention relates generally to wireless communication, and more particularly to systems and methods related to interference management between serving cells and user equipment.

### BACKGROUND

A heterogeneous network (HetNet) is a network that connects devices that use different access technologies. HetNet deployments can include systems where one or more low power nodes (LPNs) are placed indoors or outdoors throughout a geographic region. Often, these one or more LPNs provide overlapping coverage with each other or with a high powered radio tower (i.e., a Macro evolved nodeB (MeNB)). There are varying types of LPNs used in the art that can be used in networks as illustrated in Table 1.

TABLE 1
Categorization of LPNs

| | Backhaul | Access | Notes |
|---|---|---|---|
| Remote Radio | Several μs | Open to All UEs | Placed Indoors or |
| Head (RRH) | Latency to | | Outdoors |
| | Macro | | |
| Pico eNB (i.e. | X2 | Open to All UEs | Placed Indoors or |
| Node for Hot | | | Outdoors. |
| zone Cells) | | | Deployment is |
| | | | Typically Planned. |
| HeNB (i.e. | No X2 as | Closed | Typically Placed |
| Node for | Baseline | Subscriber | Indoors. |
| Femto Cells) | | Group (CSG) | Typically |
| | | | Consumer |
| | | | deployed. |
| Relay Nodes | Through Air- | Open to all UEs | Placed indoors or |
| | interface with | | outdoors |
| | a macro-cell | | |
| | (for in-band | | |
| | RN case) | | |

For example, Remote Radio Heads (RRHs) may be placed indoors and outdoors to communicate with one or more pieces of user equipment (UE) (e.g., wireless phones, etc.). Generally, RRHs have RF circuitry to receive and transmit signals, analog-to-digital and digital-to-analog converters to convert signals received and transmitted, and an interface to connect (e.g., optically coupling, electrically coupling, etc.) to a base station. The base station typically connects to the core of the network to backhaul data from the RRH. Often, this system experiences a latency of several microseconds in backhauling data between the RRH and the network core.

As another example, Pico Evolved NodeBs (eNBs) may be utilized within a HetNet. Pico eNBs are typically placed indoors or outdoors in a planned deployment. Pico eNBs typically cover small areas (i.e., approximately 200 meters or less) and can be used in small indoor areas or densely populated areas to provide areas of strong coverage to UEs. The Pico eNBs are often configured to communicate with each other through an X2 or S1 protocol. These protocols enable the Pico eNBs to manage radio resources and UE mobility. The resource management is utilized to optimize UE communication in the radio network.

As another example, Home eNBs (HeNBs), oftentimes referred to as Femto cells, are utilized within a HetNet. HeNBs are typically deployed indoors by end consumers at their homes. HeNBs typically connect to the service provider's network via a home broadband connection (e.g., cable, DSL, etc.). Accordingly, end users may improve and/or extend coverage indoors to areas of the home that would otherwise suffer from poor coverage. HeNBs are typically configured to only provide access to a limited set of predetermined users (otherwise known as a closed subscriber group (CSG)). Typically, HeNBs cannot communicate with each other through an X2 communication protocol and have a range of approximately 20 meters or less.

As another example, relay nodes are often deployed throughout a HetNet. Relay nodes utilize an over the air connection to macro base stations (e.g., radio tower) to relay signals to and from UE. The macro base stations connect to the core network. Typically, relay nodes are deployed indoors or outdoors and are open to all UEs.

RRHs, Pico eNBs, HeNBs, Relay Nodes, and MeNBs are used in varying HetNet deployment configurations as illustrated in Table 2. For example, femtocells, indoor relay nodes, and/or indoor Pico eNBs are often utilized in an indoor or outdoor environment where a MeNB also provides coverage.

TABLE 2
Example HetNet Deployment Scenarios

| | Deployment Scenario | Low power node |
|---|---|---|
| Macro + Indoor | Macro + femtocell | femtocell |
| | Macro + indoor relay | Indoor relay |
| | Macro + indoor RRH/Hot zone | e.g. indoor Pico |
| Macro + Outdoor | Macro + outdoor relay | Outdoor relay |
| | Macro + outdoor RRH/Hot zone | e.g., outdoor Pico |

These configurations involving multiple nodes often result in interference management problems. The interference characteristics in a HetNet deployment can be significantly different than the interference characteristics in a homogeneous deployment.

Several options for interference management have been proposed in “3GPP TR 36.921, FDD Home eNode B (HeNB) Radio Frequency (RF) Requirements Analysis (Release 9), v9.0.0,” the entirety of which is incorporated by reference. The several proposed options include (1) over-the-air (OTA) information, direct eNB to HeNB; (2) over-the-air information, (H)eNB to HeNB via UE; (3) X2 based interface between eNB and HeNB, and between HeNBs; and (4) S1 based interface between eNB and HeNB, and between HeNBs.

For the purpose of coordination, some information exchange between one or more victim cells and one or more interfering cells is required in order to exchange some interference management information. Options 1 and 2 require OTA information exchange which in turn requires some changes to the air interface. Options 3 and 4 are difficult to implement for femto cells because there are backhaul (either S1 or X2 based) coordination complications as described in “R1-105094 LS on eICIC progress in RAN1,” the entirety of which is incorporated by reference.

Therefore, among other advantageous effects described herein, there is a need in the prior art to provide effective implicit interference information exchange amongst LPNs to lessen issues associated with interference that may be caused by one or more LPNs in a HetNet.

### SUMMARY OF THE INVENTION

The presently disclosed embodiments are directed to solving issues relating to one or more of the problems presented in the prior art, as well as providing additional features that will become readily apparent by reference to exemplary embodiments in the following detailed description when taken in conjunction with the accompanying drawings.

According to an embodiment, one or more victim or interfering UEs are identified within the coverage area of one or more eNBs. In a further embodiment, the UEs are detected through uplink communications. In a further embodiment, the UEs are detected through a measurement of the RSRP (Reference Signal Received Power) or RSRQ (Reference Signal Received Quality) values.

According to an embodiment, the one or more eNBs in the network transmit one or more substantially blank subframes and transmit one or more substantially occupied subframes that are different than the one or more substantially blank subframes when an interfering or victim UE has been received. The victim or interfering UE receives a command from the one or more eNBs that instructs the UE to measure downlink link quality based on the CRS (Common Reference Symbol) of the serving eNB.

In a further embodiment, the downlink link quality is compared to a predetermined threshold value, a high downlink link quality above the predetermined threshold value is designated a 1 and a low downlink link quality below the predetermined threshold value is designated a 0. This comparison is provided to the eNB as a measurement report. In a further embodiment, the victim or interfering UE is scheduled in subframes whose measurement report is 1.

According to an embodiment, the one or more victim or interfering UEs communicate a measurement report that is based on the downlink link quality to the eNBs. The eNBs schedule the one or more UEs in the subframes whose measurement report indicates a high downlink link quality. In a further embodiment, one or more eNBs are one or more HeNBs or MeNBs. In a further embodiment, the one or more eNBs provide CSG access the one or more UEs. In a further embodiment, the one or more eNBs interfere with one or more MeNBs. In a further embodiment the network is a HetNet.

### BRIEF DESCRIPTION OF THE DRAWINGS

Various exemplary embodiments of the invention are described in detail below with reference to the following Figures. The drawings are provided for purposes of illustration only and merely depict exemplary embodiments of the invention. These drawings are provided to facilitate the reader's understanding of the invention and should not be considered limiting of the breadth, scope, or applicability of the invention. It should be noted that for clarity and ease of illustration these drawings are not necessarily drawn to scale.

FIG. 1 illustrates an exemplary wireless communication system for transmitting and receiving transmissions, according to an exemplary embodiment of the invention.

FIG. 2 illustrates an exemplary HetNet deployment having eNBs, UEs, and CSGs according to an exemplary embodiment of the invention.

FIG. 3(a) illustrates exemplary occupied subframes at {0, 2, 4, 6, 8} and substantially blank subframes at {1, 3, 5, 7, 9} that are transmitted by an eNB according to an exemplary embodiment of the invention.

FIG. 3(b) illustrates an exemplary designation of subframe link quality of the exemplary transmission of FIG. 3(a) according to an exemplary embodiment of the invention.

FIG. 4(a) illustrates exemplary occupied subframes at {1, 3, 5, 7, 9} and substantially blank subframes at {0, 2, 4, 6, 8} that are transmitted by an eNB according to an exemplary embodiment of the invention.

FIG. 4(b) illustrates an exemplary designation of subframe link quality of the exemplary transmission of FIG. 4(b) according to an exemplary embodiment of the invention.

### DETAILED DESCRIPTION OF EXEMPLARY EMBODIMENTS

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described herein and shown, but is to be accorded the scope consistent with the claims.

The word “exemplary” is used herein to mean “serving as an example or illustration.” Any aspect or design described herein as “exemplary” is not necessarily to be construed as preferred or advantageous over other aspects or designs.

Reference will now be made in detail to aspects of the subject technology, examples of which are illustrated in the accompanying drawings and tables, wherein like reference numerals refer to like elements throughout.

It should be understood that the specific order or hierarchy of steps in the processes disclosed herein is an example of exemplary approaches. Based upon design preferences, it is understood that the specific order or hierarchy of steps in the processes may be rearranged while remaining within the scope of the present invention. The accompanying method claims present elements of the various steps in a sample order, and are not meant to be limited to the specific order or hierarchy presented.

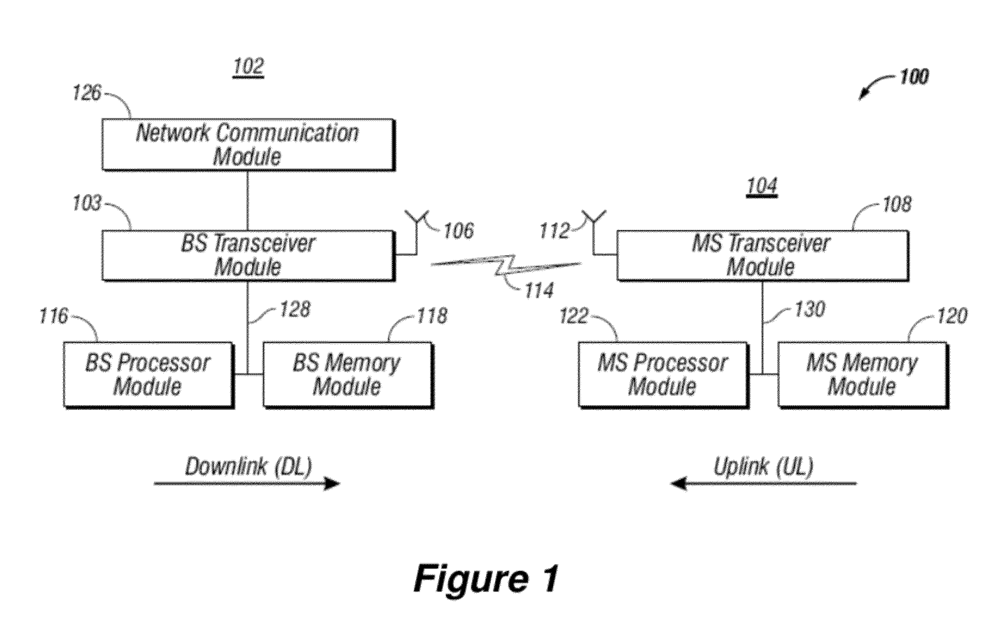

FIG. 1 illustrates an exemplary wireless communication system 100 for transmitting and receiving signals, in accordance with an embodiment of the present invention. The system 100 may include components and elements configured to support known or conventional operating features that need not be described in detail herein. System 100 generally comprises a base station 102 with a base station transceiver module 103, a base station antenna 106, a base station processor module 116 and a base station memory module 118. System 100 generally comprises a mobile station 104 with a mobile station transceiver module 108, a mobile station antenna 112, a mobile station memory module 120, a mobile station processor module 122, and a network communication module 126. Both base station 102 and mobile station 104 may include additional or alternative modules without departing from the scope of the present invention. Further, only one base station 102 and one mobile station 104 is shown in the exemplary system 100; however, any number of base stations 102 and mobile stations 104 could be included and be within the scope of the invention.

These and other elements of system 100 may be interconnected together using a data communication bus (e.g., 128, 130), or any suitable interconnection arrangement. Such interconnection facilitates communication between the various elements of the wireless system 100. Those skilled in the art understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as causing a departure from the scope of the present invention.

In the exemplary system 100, the base station transceiver 103 and the mobile station transceiver 108 each comprise a transmitter module and a receiver module (not shown). Additionally, although not shown in this figure, those skilled in the art will recognize that a transmitter may transmit to more than one receiver, and that multiple transmitters may transmit to the same receiver. In a TDD system, transmit and receive timing gaps exist as guard bands to protect against transitions from transmit to receive and vice versa.

In the particular exemplary system depicted in FIG. 1, an “uplink” transceiver 108 includes a transmitter that shares an antenna with an uplink receiver. A duplex switch may alternatively couple the uplink transmitter or receiver to the uplink antenna in time duplex fashion. Similarly, a “downlink” transceiver 103 includes a receiver which shares a downlink antenna with a downlink transmitter. A downlink duplex switch may alternatively couple the downlink transmitter or receiver to the downlink antenna in time duplex fashion.

The mobile station transceiver 108 and the base station transceiver 103 are configured to communicate via a wireless data communication link 114. The mobile station transceiver 108 and the base station transceiver 102 cooperate with a suitably configured RF antenna arrangement 106/112 that can support a particular wireless communication protocol and modulation scheme. In the exemplary embodiment, the mobile station transceiver 108 and the base station transceiver 102 are configured to support industry standards such as the Third Generation Partnership Project Long Term Evolution (3GPP LTE), Third Generation Partnership Project 2 Ultra Mobile Broadband (3GPP2 UMB), Time Division-Synchronous Code Division Multiple Access (TD-SCDMA), Wireless Interoperability for Microwave Access (WiMAX), and other communication standards known in the art. The mobile station transceiver 108 and the base station transceiver 102 may be configured to support alternate, or additional, wireless data communication protocols, including future variations of IEEE 802.16, such as 802.16e, 802.16m, and so on.

According to certain embodiments, the base station 102 controls the radio resource allocations and assignments, and the mobile station 104 is configured to decode and interpret the allocation protocol. For example, such embodiments may be employed in systems where multiple mobile stations 104 share the same radio channel which is controlled by one base station 102. However, in alternative embodiments, the mobile station 104 controls allocation of radio resources for a particular link and is configured to implement the role of radio resource controller or allocator, as described herein.

Processor modules 116/122 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration. Processor modules 116/122 comprise processing logic that is configured to carry out the functions, techniques, and processing tasks associated with the operation of system 100. In particular, the processing logic is configured to support the frame structure parameters described herein. In practical embodiments the processing logic may be resident in the base station and/or may be part of a network architecture that communicates with the base station transceiver 103.

The steps of a method or algorithm described in connection with the embodiments disclosed herein may be embodied directly in hardware, in firmware, in a software module executed by processor modules 116/122, or in any practical combination thereof. A software module may reside in memory modules 118/120, which may be realized as RAM memory, flash memory, ROM memory, EPROM memory, EEPROM memory, registers, a hard disk, a removable disk, a CD-ROM, or any other form of storage medium known in the art. In this regard, memory modules 118/120 may be coupled to the processor modules 118/122 respectively such that the processors modules 116/120 can read information from, and write information to, memory modules 118/120. As an example, processor module 116, and memory modules 118, processor module 122, and memory module 120 may reside in their respective ASICs. The memory modules 118/120 may also be integrated into the processor modules 116/120. In an embodiment, the memory module 118/220 may include a cache memory for storing temporary variables or other intermediate information during execution of instructions to be executed by processor modules 116/222. Memory modules 118/120 may also include non-volatile memory for storing instructions to be executed by the processor modules 116/120.

Memory modules 118/120 may include a frame structure database (not shown) in accordance with an exemplary embodiment of the invention. Frame structure parameter databases may be configured to store, maintain, and provide data as needed to support the functionality of system 100 in the manner described below. Moreover, a frame structure database may be a local database coupled to the processors 116/122, or may be a remote database, for example, a central network database, and the like. A frame structure database may be configured to maintain, without limitation, frame structure parameters as explained below. In this manner, a frame structure database may include a table for purposes of storing frame structure parameters.

The network communication module 126 generally represents the hardware, software, firmware, processing logic, and/or other components of system 100 that enable bi-directional communication between base station transceiver 103, and network components to which the base station transceiver 103 is connected. For example, network communication module 126 may be configured to support Internet or WiMAX traffic. In a typical deployment, without limitation, network communication module 126 provides an 802.3 Ethernet interface such that base station transceiver 103 can communicate with a conventional Ethernet based computer network. In this manner, the network communication module 126 may include a physical interface for connection to the computer network (e.g., Mobile Switching Center (MSC)).

Note that the functions described in the present disclosure may be performed by either a base station 102 or a mobile station 104. A mobile station 104 may be any user device such as a mobile phone, and any mobile station may also be referred to as UE.

Embodiments disclosed herein have specific application but not limited to the Long Term Evolution (LTE) system that is one of the candidates for the 4-th generation wireless system.

One or more base stations 102 can be utilized in HetNet deployments. The HetNet deployments may comprise any number of Pico eNBs, HeNBs, RRHs, Relay Nodes, and MeNBs. The base stations 102 may provide closed subscriber group (CSG) access or open access. One or more RRHs or Relay Nodes may be communicatively coupled to one or more base stations.

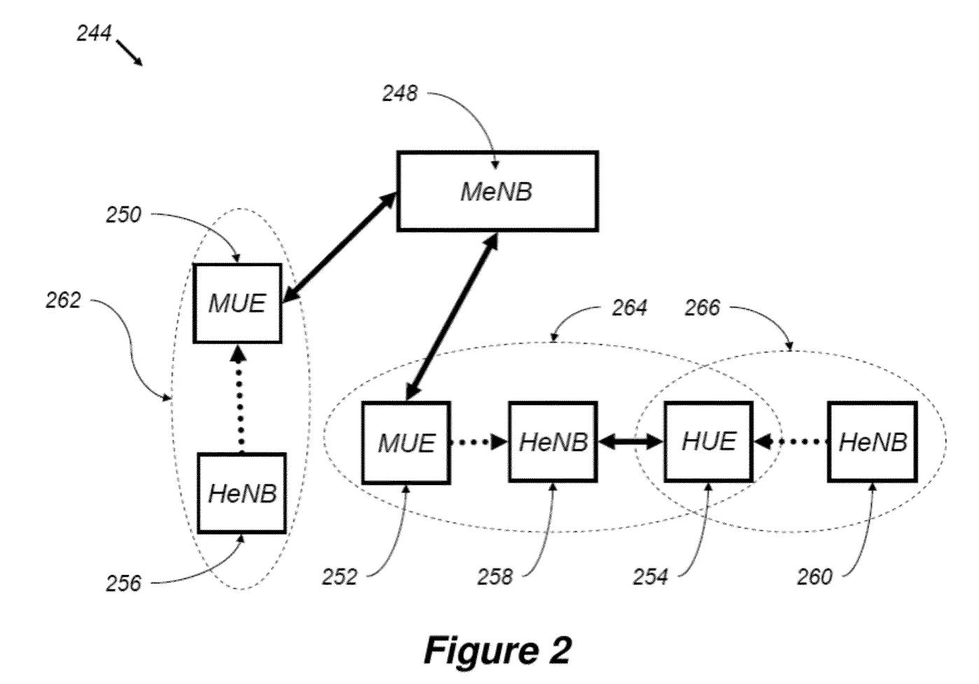

FIG. 2 illustrates an exemplary HetNet deployment 244 where a MeNB 248 is communicatively coupled to two pieces of user equipment (MUE) (250 and 252). In this example, MUE 250 is interfered with by HeNB 256, HeNB 258 is interfered with by MUE 252, and HeNB 260 interferes with HUE (home user equipment) 254. HeNB 258 can provide CSG 264 coverage to HUE 254. HeNB 256 and HeNB 260 can provide CSG coverage (262 and 266), respectively. MUE 250 and MUE 252 may not be able to access the network through the CSGs (262 and 266) provided by HeNB 256 and HeNB 258 as they may not have proper permissions. The exemplary interference scenarios illustrated in the exemplary embodiment of FIG. 2 may be lessened according to the following exemplary methods.

### Exemplary Stage One

### a) Exemplary Victim/Interfering UE Detection at HeNB

For closed accessed HeNBs where downlink interference occurs (e.g., HeNB 256 and HeNB 260), managing resources (e.g., power and subframe) can protect the downlinks for UEs in a HetNet. To apply the exemplary management scheme to protect a downlink, it can be useful to identify whether there are victim UEs in the vicinity of the HeNB. To apply the exemplary management scheme for an uplink, it can be useful to detect whether there are interfering UEs in the femto cell. Since there is no backhaul coordination assumed among macro and femto cells, according to this exemplary embodiment, the detection of the victim/interfering UEs in the vicinity of a HeNB can be done at the HeNB on the basis of detecting uplink transmissions from the victim and interfering UEs. The uplink transmission can be detected by any means known in the art as illustrated in at least “3GPP TR 36.921, FDD Home eNode B (HeNB) Radio Frequency (RF) Requirements Analysis (Release 9), v9.0.0,” the contents of which are incorporated by reference in their entirety.

### b) Exemplary New UE Measurement Mode Trigger at MeNB/HeNB

RSRP/RSRQ values can be utilized to detect interfering UEs. The RSRP measures the signal strength of an LTE cell, for example. The RSRP is the average of the power of all resource elements (REs) over the entire bandwidth that has cell-specific reference signals. The RSRQ is the ratio between the RSRP and the Received Signal Strength Indicator (RSSI).

RSRP/RSRQ of a serving cell can become worse once a MUE or a HUE is in the vicinity of a HeNB (other than its serving MeNB or HeNB). For example, the RSRP/RSRQ of the HeNB 258 can become worse when the femto cell (e.g., HeNB 260) interferes with the HUE 254 that it is servicing, for example.

A reporting in a change or a falling below a threshold of RSRP/RSRQ from a UE can indicate that the UE is a victim of interference or is causing interference itself. In this case, the MeNB or HeNB can realize that the measurement scheme should be changed. The MeNB or HeNB can signal the victim/interfering UEs for a new measurement mode in addition to the measurement modes defined by current standards known in the art. The UEs can continue to provide feedback on the new measurement mode unless informed by an eNB to turn off the new measurement mode.

According to exemplary embodiments, it can be assumed that some measurement and reporting is done at one or more UEs. The HeNBs can also measure any UL RS signal with its UL receiver. The measurement done by the UE and the measurement done at the HeNB is known in the art at least according to, for example, the 3GPP cellular standard. According to exemplary embodiments, no backhaul coordination between the MeNB and the HeNB is assumed as disclosed in “R1-105094 LS on eICIC progress in RAN1,” the entirety of which is incorporated by reference herein.

### Exemplary Stage Two

### c) Exemplary Interference Avoidance Schemes at the Interfering HeNB

If there is a victim MUE/HUE or an interfering UE, the HeNB can start interference avoidance after the interfering UE has been detected and given a new measurement mode (as illustrated in the exemplary Stage 1, described above). For example, the HeNB may only occupy part of the subframes in a frame for its own cell.

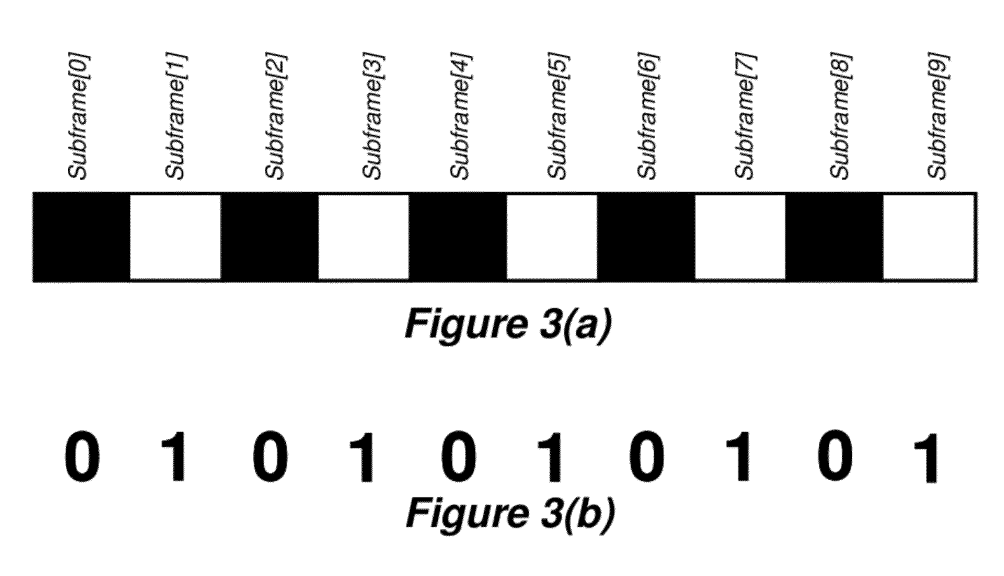

For example, after the victim MUE 250 is detected, the HeNB 256 can occupy some subframes. For example, the HeNB 256 can occupy subframes {0, 2, 4, 6, 8} for its cell and transmit substantially blank subframes in subframes {1, 3, 5, 7, 9} as illustrated in FIG. 3(a). An almost blank subframe (as described in “3GPP TS 36.133, Requirements for Support of Radio Resource Management,” the contents of which are incorporated by reference herein in their entirety) can be transmitted in a time domain interference management scheme used in HetNet. According to an exemplary embodiment, one function of time domain interference management is to partition time resources (e.g., in the unit of subframes) among different cells. However, one of ordinary skill in the art would realize that various other functions would be possible.

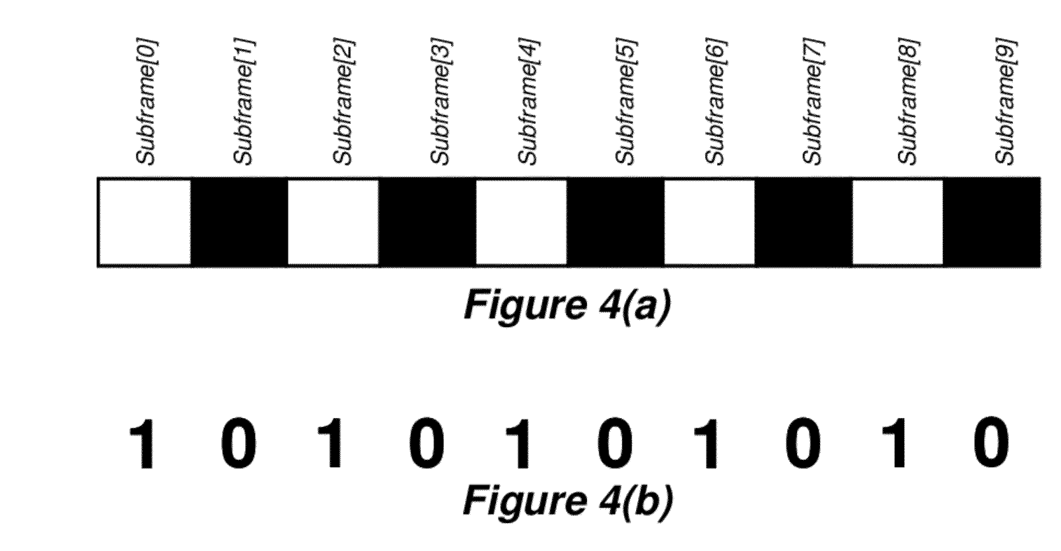

According to an exemplary embodiment, after the interferer MUE 252 has been detected, HeNB 258 can occupy subframes {1, 3, 5, 7, 9} for its cell and transmit substantially blank subframes in subframes {0, 2, 4, 6, 8} as illustrated in FIG. 4(a). The subframe allocation for the HeNB 258 may be cell specific and fixed for a predetermined time interval.

### d) New Measurement Mode at Victim/Interfering MUE/HUE

According to an exemplary embodiment, a MUE or a HUE (e.g., MUE 250, MUE 252, and/or HUE 254) can receive and follow a command to change a measurement mode. The UE can monitor the downlink link quality based on the CRS of its serving cell. According to an exemplary embodiment, this measurement can be done every subframe. According to further exemplary embodiments, the measurement of the downlink link quality can be done according to radio link measurements known in the art as illustrated in 3GPP TS 36.133: “Requirements for Support of Radio Resource Management” and 3GPP TS 36.213: “Evolved Universal Terrestrial Radio Access (E-UTRA); Physical Layer Procedures,” the entireties of both references are incorporated herein by reference.

The UE can estimate the downlink radio link quality and compare to it a predetermined threshold Q`. For example, the UE can designate a subframe a “1” if the given subframe link quality is larger than Q`. If the given subframe link quality is smaller than Q′, the UE can designate the subframe a “0.” Of course, other thresholds and/or designations may be used without departing from the scope of the present disclosure.

According to an exemplary embodiment, after the victim MUE 250 has been detected and the HeNB 256 occupies {0, 2, 4, 6, 8} for its cell and transmits substantially blank subframes in subframes {1, 3, 5, 7, 9} as illustrated in FIG. 3(a), the MUE 250 can report back [0, 1, 0, 1, 0, 1, 0, 1] for the 10 subframes to the MeNB 248 as illustrated in FIG. 3(b). Likewise, after the interfering MUE 252 has been detected and the HeNB 258 occupies {0, 2, 4, 6, 8} for its cell and transmits substantially blank subframes in subframes {1, 3, 5, 7, 9} as illustrated in FIG. 3(a), the MUE 252 can report back [0, 1, 0, 1, 0, 1, 0, 1] for the 10 subframes to the MeNB 248 as illustrated in FIG. 3(b).

According to an exemplary embodiment, after the victim HUE 254 has been detected and the HeNB 260 occupies subframes {1, 3, 5, 7, 9} for its cell and transmits substantially blank subframes in subframes {0, 2, 4, 6, 8} as illustrated in FIG. 4(a), the HUE 254 can report back [1, 0, 1, 0, 1, 0, 1, 0, 1, 0] for the 10 subframes to its serving HeNB 258 as illustrated in FIG. 4(b). According to these exemplary embodiments, the link quality for UE of a non transmitted subframe of an interfering eNB is higher.

According to an exemplary embodiment, the threshold Q` and the new measurement mode period can be fixed or dynamic. A fixed threshold would require no further eNB signaling and a dynamic threshold could utilize eNB signaling.

### Exemplary Stage Three

### e) Exemplary Interference Avoidance at the Interfered MeNB/HeNB

According to an exemplary embodiment, once the serving cell of the victim UE receives the new measurement report from the UE, the eNB can add some restrictions to its scheduler. These restrictions can be configured to schedule the victim UE in those subframes whose new measurement report is 1. In other words, those subframes would likely be the subframes where the interfering eNB transmits substantially blank subframes.

According to an exemplary embodiment, the MeNB 248 can schedule the victim MUEs (250 and 252) in subframes {1, 3, 5, 7, 9} when, as according to example c) and FIG. 3(a), the HeNBs (256 and 258) occupy subframes {0, 2, 4, 6, 8} and transmit substantially blank subframes in subframes {1, 3, 5, 7, 9}.

According to an exemplary embodiment, the HeNB 258 can schedule the victim HUE 254 in subframes {0, 2, 4, 6, 8} when, as according to example c) and FIG. 4(a), the HeNB 260 occupies subframes {1, 3, 5, 7, 9} and transmits substantially blank subframes in subframes {0, 2, 4, 6, 8}.

According to an exemplary embodiment, when the UEs (250, 252, 254) leave the coverage areas of their respective interfering HeNBs (256, 258, 260), the normal measurement event based on RSPR/RSRQ can be triggered where the serving cell signal is higher than some predetermined threshold. The serving eNBs (MeNB 248 and HeNB 258) can change the measurement scheme back by signaling to the respective UEs (250, 252, 254) to turn off the new measurement mode, according to one example.

Although exemplary embodiments herein have been described in reference to a specific exemplary HetNet, it should be understood that any configuration of LPNs utilizing any number and types of eNBs within a network are within the scope of this disclosure. It is further conceived that any access or communication scheme between UEs and LPNs can be utilized. Although a MeNB has been disclosed, it is conceived that HeNBs may be deployed absent MeNB coverage. Likewise, any LPN may be present with or without another.

The stages 1-3 and the steps a-e are exemplary embodiments, and one of ordinary skill in the art would realize that variations may be possible, within the scope of the disclosure. Of course, any stage or method step may be taken in any order. Further, certain steps may be skipped or other steps added.

The subframe configurations described in FIGS. 3(a) and 4(a) are exemplary. One of ordinary skill in the art would realize that any number of subframes may be occupied and any number of subframes may be transmitted as substantially blank in any order. Likewise, the configurations disclosed herein in FIGS. 3(b) and 4(b) to designate blank and transmitted subframes are exemplary. Various methods of designating blank and occupied subframes can be used.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but can be implemented using a variety of alternative architectures and configurations. Additionally, although the invention is described above in terms of various exemplary embodiments and implementations, it should be understood that the various features and functionality described in one or more of the individual embodiments are not limited in their applicability to the particular embodiment with which they are described, but instead can be applied, alone or in some combination, to one or more of the other embodiments of the invention, whether or not such embodiments are described and whether or not such features are presented as being a part of a described embodiment. Thus the breadth and scope of the present invention should not be limited by any of the above-described exemplary embodiments.

What is claimed is:

1. A method for interference management in a network comprising one or more evolved nodeBs (eNBs), the method comprising:
detecting one or more victim or interfering mobile stations within the coverage area of the one or more eNBs;
transmitting one or more substantially blank subframes and one or more occupied subframes that are different than the one or more substantially blank subframes when the one or more victim or interfering mobile stations are detected;
transmitting a command to the one or more victim or interfering mobile stations, wherein the command instructs each of the one or more victim or interfering mobile stations to measure downlink link quality based on one or more common reference symbol (CRS) of its serving eNB;
receiving a measurement report providing downlink link quality from the one or more victim or interfering mobile stations; and
scheduling the one or more victim or interfering mobile stations in one or more subframes having a high downlink link quality.

2. The method according to claim 1 further comprising:
comparing, for the one or more victim or interfering mobile stations, the downlink link quality with a predetermined threshold value, wherein a high downlink link quality above the predetermined threshold value is designated a 1 and a low downlink link quality below the predetermined threshold value is designated a 0; and
reporting results of the comparison to the one or more eNBs as the measurement report.

3. The method according to claim 2 wherein the threshold is dynamic.

4. The method according to claim 1 further comprising providing closed subscriber group (CSG) access from at least one of the one or more eNBs.

5. The method according to claim 1 further comprising triggering a normal measurement event on the one or more victim or interfering mobile stations when they are no longer subject to or providing interference.

6. The method according to claim 1 wherein the one or more eNBs include at least one Home eNB.

7. The method according to claim 1 wherein the one or more victim or interfering mobile stations are detected through uplink communications.

8. The method according to claim 1 further comprising generating a measurement mode trigger from the one or more victim or interfering mobile stations when there is a change in a measurement value of at least one of the (Reference Signal Received Power) RSRP or (Reference Signal Received Quality) RSRQ, the measurement mode trigger identifies one or more victim or interfering mobile stations.

9. The method according to claim 1 further comprising generating the measurement report for every subframe.

10. A system, comprising:
one or more evolved nodeBs (eNBs), each configured to:
detect one or more victim or interfering mobile stations;
transmit one or more substantially blank subframes and occupy one or more subframes that are different than the one or more substantially blank subframes when one or more victim or interfering mobile stations are detected;
transmit a command to the one or more victim or interfering mobile stations, the command instructing the one or more victim or interfering mobile stations to measure downlink link quality based on a Common Reference Symbol (CRS) of its serving eNB,
receive a measurement report based on the downlink link quality from the one or more victim or interfering mobile stations, and
schedule the one or more mobile stations in one or more subframes whose measurement report indicates a high downlink link quality.

11. The system according to claim 10, wherein the one or more eNBs are further configured to:
transmit a command to measure downlink link quality to the one or more victim or interfering mobile stations.

12. The system according to claim 11 wherein the one or more victim or interfering mobile stations are configured to:
compare the downlink link quality to a predetermined threshold value, wherein a high downlink link quality above the predetermined threshold value is designated a 1 and a low downlink link quality below the predetermined threshold value is designated a 0; and
report results of the comparison to the one or more eNBs as the measurement report.

13. The system according to claim 12 wherein the threshold is dynamic.

14. The system according to claim 10, wherein the one or more eNBs are configured to detect the victim or interfering mobile stations through uplink communications.

15. The system according to claim 10, wherein the one or more eNBs are configured to receive a measurement mode trigger from the one or more victim or interfering mobile stations when there is a change in a measurement value of the Reference Signal Received Power (RSRP) or Reference Signal Received Quality (RSRQ), and the measurement mode trigger identifies the one or more victim or interfering mobile stations.

16. The system according to claim 10 wherein one or more eNBs are one or more Home eNBs.

17. The system according to claim 10 wherein the one or more eNBs are configured to provide closed subscriber group (CSG) access.

18. A non-transitory computer-readable medium storing instructions thereon for, when executed by a processor, performing a method of interference management in a network comprising one or more evolved nodeBs (eNBs), the method comprising:
detecting one or more victim or interfering mobile stations within the coverage area of the one or more eNBs;
transmitting one or more substantially blank subframes and one or more occupied subframes that are different than the one or more substantially blank subframes when the one or more victim or interfering mobile stations are detected;
transmitting a command to the one or more victim or interfering mobile stations, wherein the command instructs each of the one or more victim or interfering mobile stations to measure downlink link quality based on one or more Common Reference Symbols (CRSs) of its serving eNB;
receiving a measurement report providing downlink link quality from the one or more victim or interfering mobile stations; and
scheduling the one or more victim or interfering mobile stations in one or more subframes having a high downlink link quality.

19. The computer-readable medium according to claim 18, the method further comprising:
comparing, for the one or more victim or interfering mobile stations, the downlink link quality with a predetermined threshold value, wherein a high downlink link quality above the predetermined threshold value is designated a 1 and a low downlink link quality below the predetermined threshold value is designated a 0; and
reporting results of the comparison to the one or more eNBs as the measurement report.

20. The computer-readable medium according to claim 19 wherein the threshold is dynamic.

21. The computer-readable medium according to claim 18, the method further comprising providing closed subscriber group (CSG) access from at least one of the one or more eNBs.

22. The computer-readable medium according to claim 18, the method further comprising triggering a normal measurement event on the one or more victim or interfering mobile stations when they are no longer subject to or providing interference.

23. The computer-readable medium according to claim 18 wherein the one or more eNBs include at least one Home eNB.

24. The computer-readable medium according to claim 18 wherein the one or more victim or interfering mobile stations are detected through uplink communications.

25. The computer-readable medium according to claim 18, the method further comprising generating a measurement mode trigger from the one or more victim or interfering mobile stations when there is a change in a measurement value of at least one of the Reference Signal Received Power (RSRP) or Reference Signal Received Quality (RSRQ), the measurement mode trigger identifies one or more victim or interfering mobile stations.

26. The computer-readable medium according to claim 18, the method further comprising generating the measurement report for every subframe.
